(19) United States
(12) Patent Application Publication
(10) Pub. No.: US 2015/0176904 A1
(43) Pub. Date: Jun. 25, 2015

(54) SAMPLE HOLDER FOR ANNEALING APPARATUS AND ELECTRICALLY ASSISTED ANNEALING APPARATUS USING THE SAME

(71) Applicant: Industrial Technology Research Institute, Hsinchu (TW)

(72) Inventors: Hsu-Shen Chu, Hsinchu City (TW); Chien-Neng Liao, Taichung City (TW); Yao-Hsiang Chen, Tainan City (TW)

(21) Appl. No.: 14/547,152

(22) Filed: Nov. 19, 2014

(30) Foreign Application Priority Data
Dec. 25, 2013 (TW) 102148226

(51) Int. Cl. F27D 11/02; F27D 21/00; F27D 19/00; C21D 9/00; F27D 5/00

(52) U.S. Cl. CPC F27D 11/02; C21D 9/0025; C21D 9/0006; F27D 5/0006; F27D 19/00; F27D 21/0014; F27D 2019/0003

(57) ABSTRACT

A sample holder for annealing apparatus and electrically assisted annealing apparatus using the same are provided. The sample holder includes a heat conductive shell, high thermal conductive and electrical insulation blocks, first and second electrodes. The heat conductive shell includes a base frame and a top cover. The high thermal conductive and electrical insulation blocks are adjacent to the base frame and the top cover, respectively, and a sample pallet is sandwiched therebetween. Length and width of the sample pallet is smaller than that of the high thermal conductive and electrical insulation blocks. The first and the second electrodes are fixed to two sides of the sample pallet, and are connected to electrifying wire respectively. Thickness of the first and the second electrodes is smaller than that of the sample pallet, while the width of the first and the second electrodes is longer than that of the sample pallet.

### CROSS-REFERENCE TO RELATED APPLICATION

This application claims the priority benefit of Taiwan application serial no. 102148226, filed on Dec. 25, 2013. The entirety of the above-mentioned patent application is hereby incorporated by reference herein and made a part of this specification.

### BACKGROUND

1. Technical Field

The disclosure relates to a sample holder for annealing apparatus and an electrically assisted annealing apparatus using the same.

2. Related Art

Thermoelectric material is capable of converting electric energy and thermal energy through a Seebeck effect or a Peltier effect. Since the thermoelectric material is a solid state material, and a thermoelectric module using the thermoelectric material has no moving part, the thermoelectric module has advantages of high reliability, long service life and no noise, etc. Performance of the thermoelectric module relates to a thermoelectric material characteristic, hot and cold end temperature (Tᵣₒₜ and T_{cold}) of the module and temperature difference (ΔT), where the thermoelectric material characteristic is represented by a figure of merit (ZT) value. The ZT value mainly relates to a Seebeck coefficient, electrical conductivity and a thermal conductivity, and the above three parameters also directly determine whether the material has a good thermoelectric property. The higher the ZT value is, the more obvious the thermoelectric effect is, and a relationship thereof is:

$$ZT = \frac{{α}^{2} σ}{k} T$$

Where, α is the Seebeck coefficient, σ is the electrical conductivity, k is the thermal conductivity, and T is the absolute temperature.

Recent studies show that microstructures (for example, nanocrystallin and precipitated phases, etc.) may increase the ZT value of the thermoelectric material. Suitable annealing step ensures nanophase precipitation of the nanocrystallin of the thermoelectric material after hot-pressing consolidation, and eliminates lattice defects, etc., so as to achieve ideal nanoscale microstructures and thermoelectric characteristic.

### SUMMARY

An embodiment of the disclosure provides a sample holder for annealing apparatus including a heat conductive shell, high thermal conductive and electrical insulation blocks, a first electrode and a second electrode. The heat conductive shell includes a base frame and a top cover. The high thermal conductive and electrical insulation blocks are respectively disposed adjacent to the top of the base frame and the bottom of the top cover, and a sample pallet is sandwiched between the high thermal conductive and electrical insulation blocks. The first electrode and the second electrode are disposed opposite to each other between the high thermal conductive and electrical insulation blocks for contacting the sample pallet.

An embodiment of the disclosure provides an electrically assisted annealing apparatus including a sealed cavity, a heater and the aforementioned sample holder for annealing apparatus disposed in the sealed cavity, and a first data extractor, a second data extractor, a temperature controller, a mechanical pump, a power supplier, a gas flow meter and pressure gauge, and a thermocouple external female connector disposed outside the sealed cavity. The sample holder for annealing apparatus is disposed on the heater. The first data extractor extracts a temperature of a sample pallet. The second data extractor extracts a temperature of the heater. The temperature controller adjusts a power supplied to the heater according to the temperature of the sample pallet extracted by the first data extractor. The power supplier supplies a current to the sample pallet. The gas flow meter and pressure gauge controls a gas inlet to the sealed cavity. The thermocouple external female connector is connected to the thermocouple of the sample holder for annealing apparatus and the first data extractor and the temperature controller.

In order to make the aforementioned and other features and advantages of the disclosure comprehensible, several exemplary embodiments accompanied with figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic diagram of a sample holder according to the disclosure.

FIG. 2A is a top view of a base frame according to an embodiment of the disclosure.

FIG. 2B is a side view of FIG. 2A along a line I-I′.

FIG. 2C is a top view of a sample holder without a top cover according to an embodiment of the disclosure.

FIG. 2D is a side view of FIG. 2C along a line I-I′.

FIG. 2E is a top view of a sample holder according to an embodiment of the disclosure.

FIG. 2F is a schematic diagram of a top cover according to an embodiment of the disclosure.

FIG. 2G is a side view of FIG. 2E along a line I-I′.

FIG. 2H is a side view of FIG. 2E along a line II-II′.

FIG. 3A and FIG. 3B are schematic diagrams of an electrically assisted annealing apparatus according to an embodiment of the disclosure.

FIG. 4 is a control flowchart of the electrically assisted annealing apparatus of the disclosure.

FIG. 5 illustrates temperature variations of sample pallets of an example 1 and a comparison 1 under different current densities.

FIG. 6A, FIG. 6B and FIG. 6C are respectively microstructure images of the sample pallet of an example 2 in an electrically assisted annealing treatment under different temperatures (230° C., 270° C., 300° C.).

FIG. 7A, FIG. 7B and FIG. 7C are respectively microstructure images of the sample pallet of a comparison 2 in a simple thermal annealing treatment (without electrical assistance) under different temperatures (230° C., 270° C., 300° C.).

FIG. 8 is a diagram illustrating a relationship of a Seebeck coefficient α and a electrical resistivity ρ of Bi—Te—Se sample pallets of an example 3, an example, 4 and a comparison 3 in case of electrically assisted annealing treatment under 275° C. and a current density of 333 A/cm², and in case of a simple thermal annealing treatment under 275° C.

### DETAILED DESCRIPTION OF DISCLOSED EMBODIMENTS

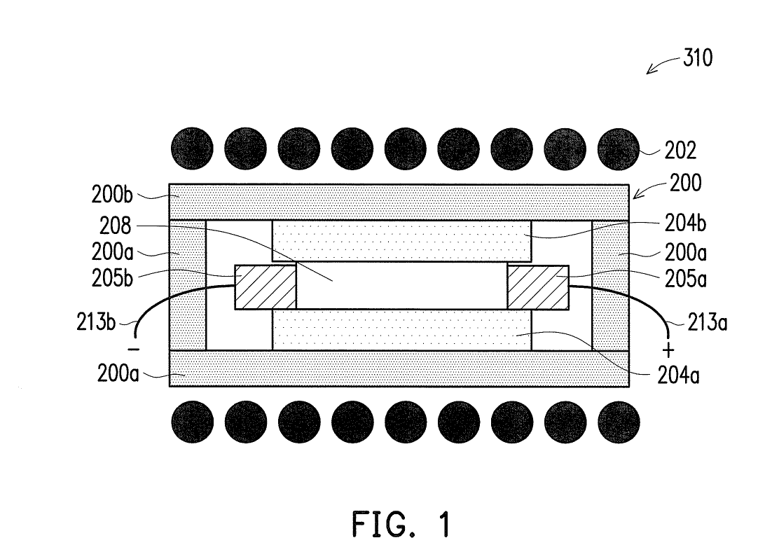

FIG. 1 is a schematic diagram of a sample holder for annealing apparatus according to the disclosure.

Referring to FIG. 1, the sample holder 310 for annealing apparatus of the disclosure includes a heat conductive shell 200, high thermal conductive and electrical insulation blocks 204a and 204b, a first electrode 205a and a second electrode 205b.

Referring to FIG. 1, the heat conductive shell 200 includes a base frame 200a and a top cover 200b. The base frame 200a and the top cover 200b are assembled to form a space. The high thermal conductive and electrical insulation blocks 204a and 204b are respectively disposed adjacent to the top of the base frame 200a and the bottom of the top cover 200b. A sample pallet 208 is sandwiched between the high thermal conductive and electrical insulation blocks 204a and 204b. The first electrode 205a and the second electrode 205b are fixed at two sides of the sample pallet 208 and contact the sample pallet 208. The first electrode 205a and the second electrode 205b are respectively connected to electrifying wires 213a and 213b. A heating device 202 can be installed outside the heat conductive shell 200 of the sample holder 310 for annealing apparatus of the disclosure to serve as a heat source for regulating an annealing temperature. The heating device 202 can be a contact type conduction resistance heating device, a non-contact type radiation heating device or a sensing heating device, etc.

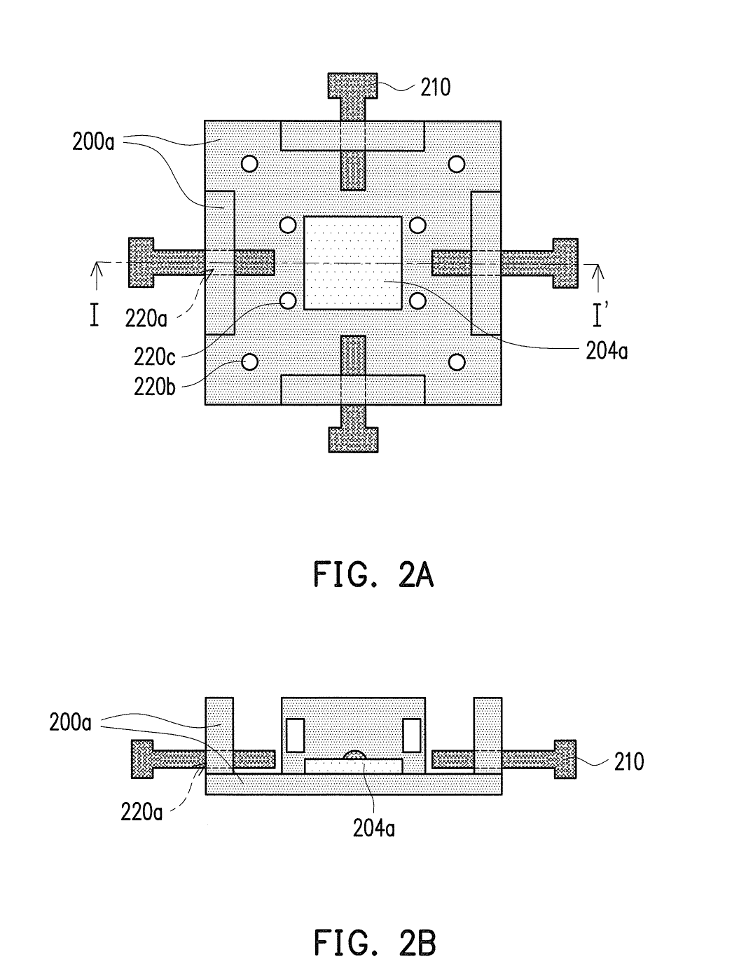

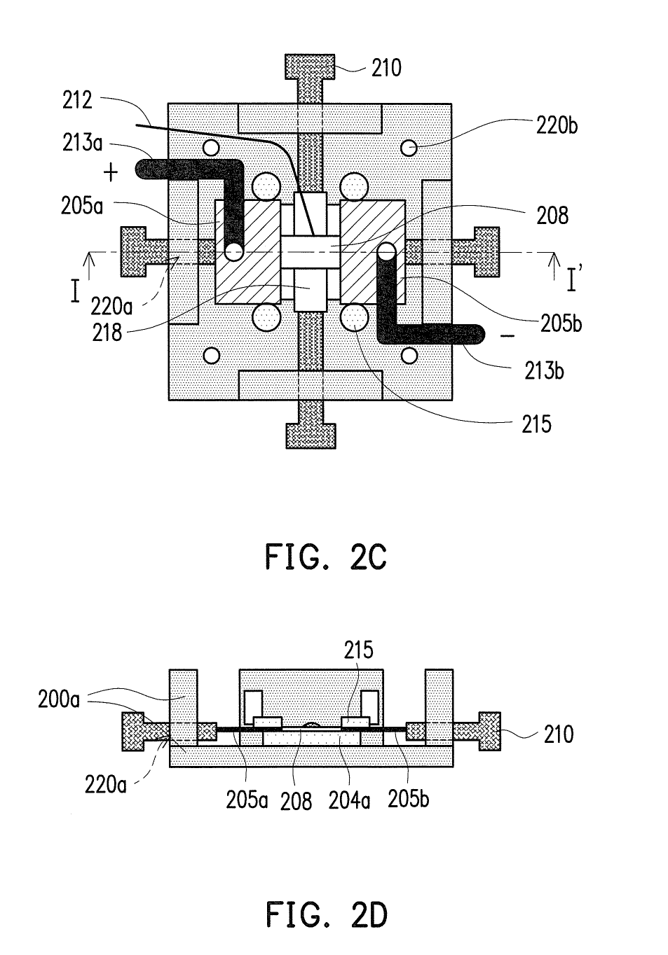

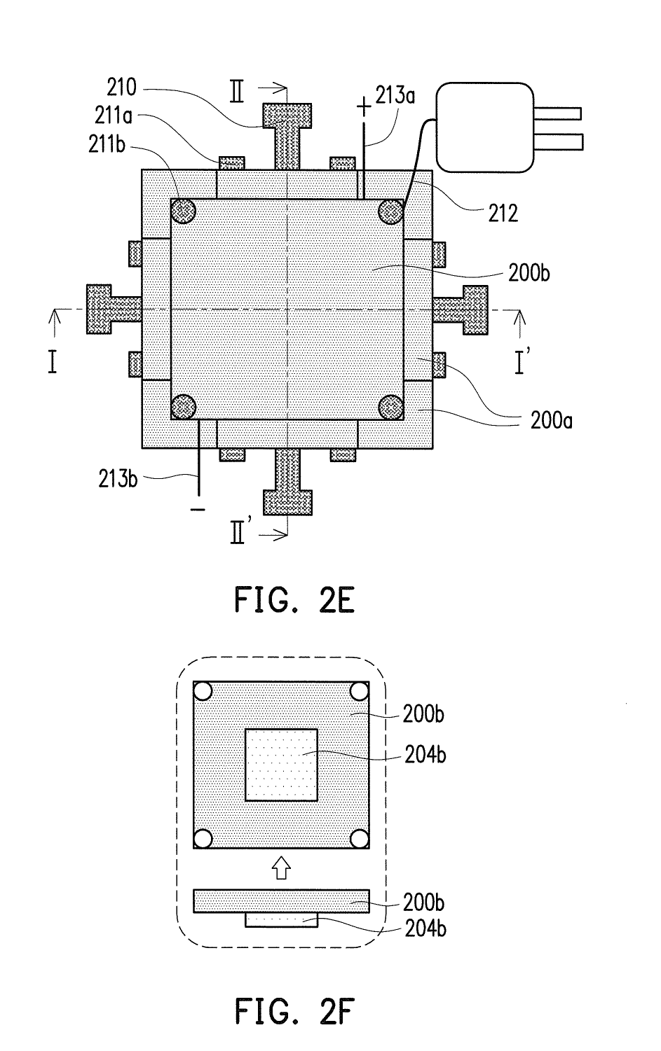

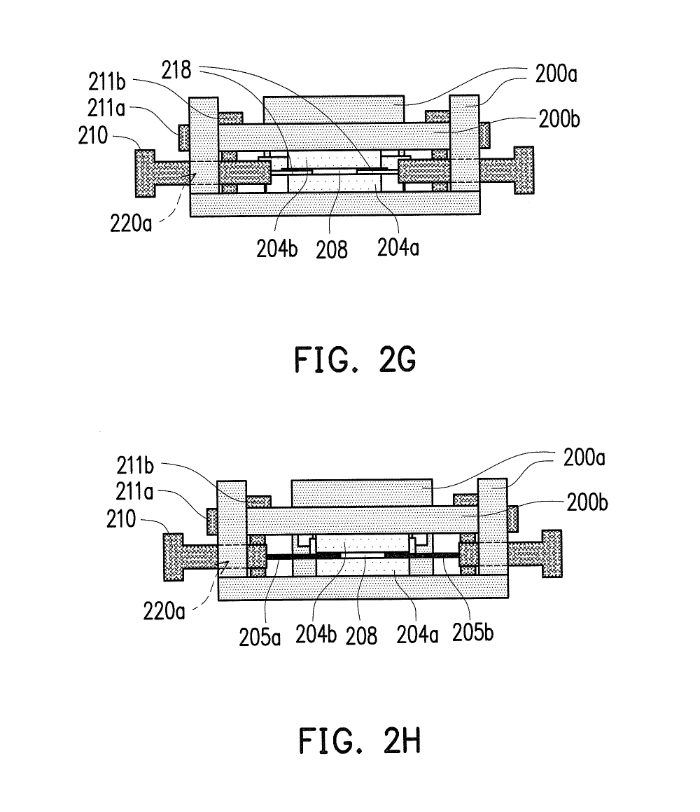

FIG. 2A is a top view of the base frame according to an embodiment of the disclosure. FIG. 2B is a cross-sectional view of the base frame according to an embodiment of the disclosure. FIG. 2C is a top view of the sample holder without the top cover according to an embodiment of the disclosure. FIG. 2D is a cross-sectional view of the sample holder without the top cover according to an embodiment of the disclosure.

Referring to FIG. 1, FIG. 2A and FIG. 2B, the heat conductive shell 200 includes the base frame 200a and the top cover 200b. The base frame 200a and the top cover 200b can be assembled to form a space. A material of the base frame 200a of the heat conductive shell 200 can be metal, alloy or a combination thereof, for example, copper, aluminium, etc., alloy or metal-based composite materials that have a high thermal conductivity. In an embodiment of the disclosure, the material of the heat conductive shell 200 is copper. A bottom surface of the base frame 200a may have any shape including square, rectangle, polygon or circle. In an embodiment of the disclosure, the bottom surface of the base frame 200a is a square. In an embodiment, the base frame 200a is made of a copper block, and sidewalls of the base frame 200a have holes 220a, and the bottom surface has lateral holes 220b and medial holes 220c.

Referring to FIG. 1, FIG. 2A and FIG. 2B, the high thermal conductive and electrical insulation block 204a is disposed on the top of the base frame 200a. Thermal conductivity of the high thermal conductive and electrical insulation block 204a is between 30 W/mK and 180 W/mK. The high thermal conductive and electrical insulation block 204a can be made of a ceramic material, metal with a surface treated with isolation treatment, alloy with a surface treated with isolation treatment or a combination thereof. The ceramic material is, for example, boron nitride (BN), aluminium nitride (AlN), beryllium oxide (BeO) or a combination thereof. The metal is, for example, copper or aluminium. In an embodiment of the disclosure, the high thermal conductive and electrical insulation block 204a is made of BN. The sample pallet 208 can be sandwiched between the high thermal conductive and electrical insulation blocks 204a and 204b, where a length and a width of each of the high thermal conductive and electrical insulation blocks 204a and 204b are greater than a length and a width of the sample pallet 208, i.e. an area of each of the high thermal conductive and electrical insulation blocks 204a and 204b is greater than an area of the sample pallet 208, and the high thermal conductive and electrical insulation blocks 204a and 204b can cover the sample pallet 208.

Referring to FIG. 1, FIG. 2C and FIG. 2D, the first electrode 205a and the second electrode 205b are fixed at two sides of the sample pallet 208 and contact the sample pallet 208. A thickness of each of the first electrode 205a and the second electrode 205b is smaller than a thickness of the sample pallet 208, and a width of each of the first electrode 205a and the second electrode 205b is greater than a width of the sample pallet 208, such that the sample pallet 208 can entirely and closely contact the high thermal conductive and electrical insulation blocks 204a and 204b. A material of the first electrode 205a and the second electrode 205b includes metal or alloy, for example, gold, silver, copper, nickel or an alloy thereof. In an embodiment of the disclosure, a material of the first electrode 205a and the second electrode 205b is nickel.

Referring to FIG. 1, FIG. 2A to FIG. 2D, the sample holder 310 for annealing apparatus includes the heat conductive shell 200, the high thermal conductive and electrical insulation blocks 204a and 204b, the first electrode 205a and the second electrode 205b, and further includes fixing screws 210. The fixing screws 210 can penetrate through the holes 220a of the base frame 200a from the outside to tightly press the first electrode 205a and the second electrode 205b against the two sides of the sample pallet 208. The fixing screws 210 are, for example, ceramic screws or plastic screws. A material of the fixing screw 210 is, for example, zirconium oxide (ZrO₂), aluminium oxide (Al₂O₃), polyetheretherketone (PEEK) or polybenzimidazole (PBI). At the inner side of the base frame 200a, heat-resistant screws 215 can be used to penetrate through the holes 220c of the base frame 200a to tightly press against the first electrode 205a and the second electrode 205b, so as to prevent warping of the first electrode 205a and the second electrode 205b. The heat-resistant screws 215 are, for example, PBI isolation heat-resistant screws, ZrO₂ or Al₂O₃ heat-resistant screws or PEEK heat-resistant screws. The first electrode 205a and the second electrode 205b contact the sample pallet 208, and are respectively connected to electrifying wires 213a and 213b. In the present embodiment, screws are used to fix various components, though the disclosure is not limited thereto, and in other embodiments, springs or leaf springs can also be used.

Referring to FIG. 2C and FIG. 2D, the sample holder 310 for annealing apparatus may further include fixing sheets 218. The fixing sheets 218 are respectively disposed between the sample pallet 208 and the first electrode 205a and between the sample pallet 208 and the second electrode 205b, and are fixed through the fixing screws 210 from external. The fixing sheets 218 can be made of an insulation material, for example, a ceramic material, glass, ZrO₂, Al₂O₃ or a combination thereof.

Referring to FIG. 2C and FIG. 2D, a thermocouple 212 can be further configured to any side of the sample pallet 208. The thermocouple 212 is sandwiched between the sample pallet 208 and the fixing sheet 218, and is fixed through the fixing sheet 218 and the fixing screw 210, such that the thermocouple 212 completely contacts the sample pallet 208 to measure an actual annealing temperature of the sample pallet 208.

Moreover, the first electrode 205a and the second electrode 205b are respectively connected to the electrifying wires 213a and 213b, so that a DC current can be inlet to the sample pallet 208. The first electrode 205a can be positive or negative, and the second electrode 205b can be negative or positive. In an embodiment, the first electrode 205a connected to the electrifying wire 213a is a positive electrode, and the second electrode 205b connected to the electrifying wire 213b is a negative electrode.

FIG. 2E is a top view of a sample holder according to an embodiment of the disclosure. FIG. 2F is a schematic diagram of a top cover according to an embodiment of the disclosure. FIG. 2G is a cross-sectional view of FIG. 2E along a line I-I′. FIG. 2H is a cross-sectional view of FIG. 2E along a line II-II′.

Referring to FIG. 2E to FIG. 2H, the top cover 200b can be fixed to the base frame 200a through fixing screws 211a and 211b. The fixing screws 211a and 211b are not necessarily to be made of insulation materials, for example, can be metal screws. The top cover 200b of the heat conductive shell 200 may have any shape including square, rectangle, polygon or circle. In an embodiment of the disclosure, the top cover 200b is a square. The high thermal conductive and electrical insulation block 204b is disposed under the top cover 200b. When the fixing screw 211b is tightened, the high thermal conductive and electrical insulation block 204b and the sample pallet 208 are closely attached. The thermal conductivity of the high thermal conductive and electrical insulation block 204b is between 30 W/mK to 200 W/mK. The material of the high thermal conductive and electrical insulation block 204b can be the same of different to the material of the high thermal conductive and electrical insulation block 204a. The high thermal conductive and electrical insulation block 204b includes a ceramic material, metal with a surface treated with isolation treatment, alloy with a surface treated with isolation treatment or a combination thereof. The ceramic material is, for example, boron nitride (BN), aluminium nitride (AlN), beryllium oxide (BeO) or a combination thereof. The metal is, for example, copper or aluminium. In an embodiment of the disclosure, the high thermal conductive and electrical insulation block 204b is made of BN. The sample pallet 208 can be sandwiched between the high thermal conductive and electrical insulation blocks 204a and 204b, where the length and the width of each of the high thermal conductive and electrical insulation blocks 204a and 204b are greater than the length and the width of the sample pallet 208, i.e. the area of each of the high thermal conductive and electrical insulation blocks 204a and 204b is greater than the area of the sample pallet 208, and the high thermal conductive and electrical insulation blocks 204a and 204b can cover the sample pallet 208.

Referring to FIG. 2A and FIG. 2B, before the test is performed, the high thermal conductive and electrical insulation block 204a has been disposed on the base frame 200a. The fixing screws 210 are disposed on the base frame 200a through the holes 220a.

Referring to FIG. 2C and FIG. 2D, the sample pallet 208 can be disposed on the high thermal conductive and electrical insulation block 204a on the base frame 200a (FIG. 2A and FIG. 2B). By tightening the fixing screws 210, the first electrode 205a and the second electrode 205b are tightly pressed against the two sides of the sample pallet 208. At the inner side of the base frame 200a, the heat-resistant screws 215 can be used to penetrate through the holes 220c of the base frame 200a to tightly press against the first electrode 205a and the second electrode 205b, so as to prevent warping of the first electrode 205a and the second electrode 205b. The fixing sheets 218 are respectively disposed between the sample pallet 208 and the first electrode 205a and between the sample pallet 208 and the second electrode 205b, and are fixed through the fixing screws 210 from external. The thermocouple 212 is sandwiched between the sample pallet 208 and the fixing sheet 218, and is fixed through the fixing sheet 218 and the fixing screw 210, such that the thermocouple 212 completely contacts the sample pallet 208.

Referring to FIG. 2E and FIG. 2F, the top cover 200b can be fixed to the base frame 200a through the fixing screws 211a and 211b. When the fixing screw 211b is tightened, the high thermal conductive and electrical insulation block 204b can tightly press the sample pallet 208.

When the test is performed, a heating source can be provided at periphery of the heat conductive shell 200 for annealing treatment. Since the high thermal conductive and electrical insulation blocks 204a and 204b are made of a material with high thermal conductivity, in the annealing treatment, if a temperature of the sample pallet 208 is lower than a preset annealing temperature, the heat provided at periphery of the heat conductive shell 200 can be conducted to the sample pallet 208 through the high thermal conductive and electrical insulation blocks 204a and 204b to increase the temperature of the sample pallet 208. If the temperature of the sample pallet 208 is higher than the preset annealing temperature, the excessive heat can be conducted from the sample pallet 208 to the heat conductive shell 200 through the high thermal conductive and electrical insulation blocks 204a and 204b to decrease the temperature of the sample pallet 208. In this way, the annealing temperature can be effectively controlled. The actual annealing temperature of the sample pallet 208 can be measured through the thermocouple 212. The electrifying wires 213a and 213b can be used to provide currents of different values to the sample pallet 208. Therefore, the sample holder 310 for annealing apparatus of the disclosure can simultaneously set a current magnitude and the annealing temperature.

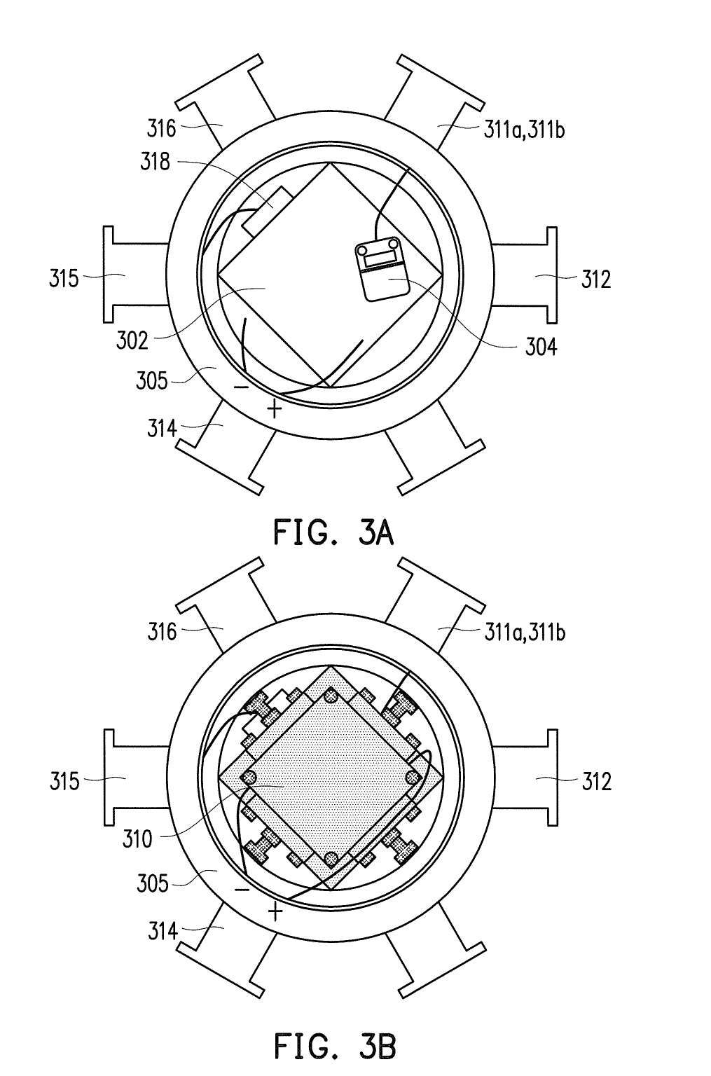

FIG. 3A and FIG. 3B are schematic diagrams of an electrically assisted annealing apparatus according to an embodiment of the disclosure.

Referring to FIG. 3A, a heater 302 and a thermocouple external female connector 304 are configured in a sealed cavity 305, and the heater 302 is connected to a heater thermocouple 318.

Referring to FIG. 3A and FIG. 3B, a plurality of functional parts are configured outside the sealed cavity 305, which include a first data extractor 311a and a temperature controller 311b, a mechanical pump 312, a power supplier 314, a second data extractor 315, a gas flow meter and pressure gauge 316. The aforementioned sample holder 310 of the disclosure can be disposed on the heater 302. The thermocouple 212 (shown in FIG. 2C) of the sample holder 310 is connected to the thermocouple external female connector 304. The electrifying wires 213a and 213b (shown in FIG. 1 and FIG. 2C) of the sample holder 310 are connected to the power supplier 314. The first data extractor 311a and the temperature controller 311b are all connected to the thermocouple external female connector 304 for measuring and extracting the temperature of the sample pallet 208 (shown in FIG. 2C). The temperature controller 311b is, for example, a proportional-integral-derivative controller (PID controller), which is used for adjusting a power supplied to the heater 302 so that the heater 302 can conduct heating. The mechanical pump 312 maintains a vacuum state of the sealed cavity 305. The power supplier 314 can be a DC power supplier, which is adapted to inlet a DC current to the sample pallet 208 in the sample holder 310 (FIG. 2C), and set a magnitude of the current inlet to the sample holder 310. The second data extractor 315 is connected to the heater thermocouple 318, and displays and records a temperature of the heater 302. The gas flow meter and pressure gauge 316 controls a gas inlet to the sealed cavity 305, and the gas inlet to the sealed cavity 305 includes nitrogen or inert gas.

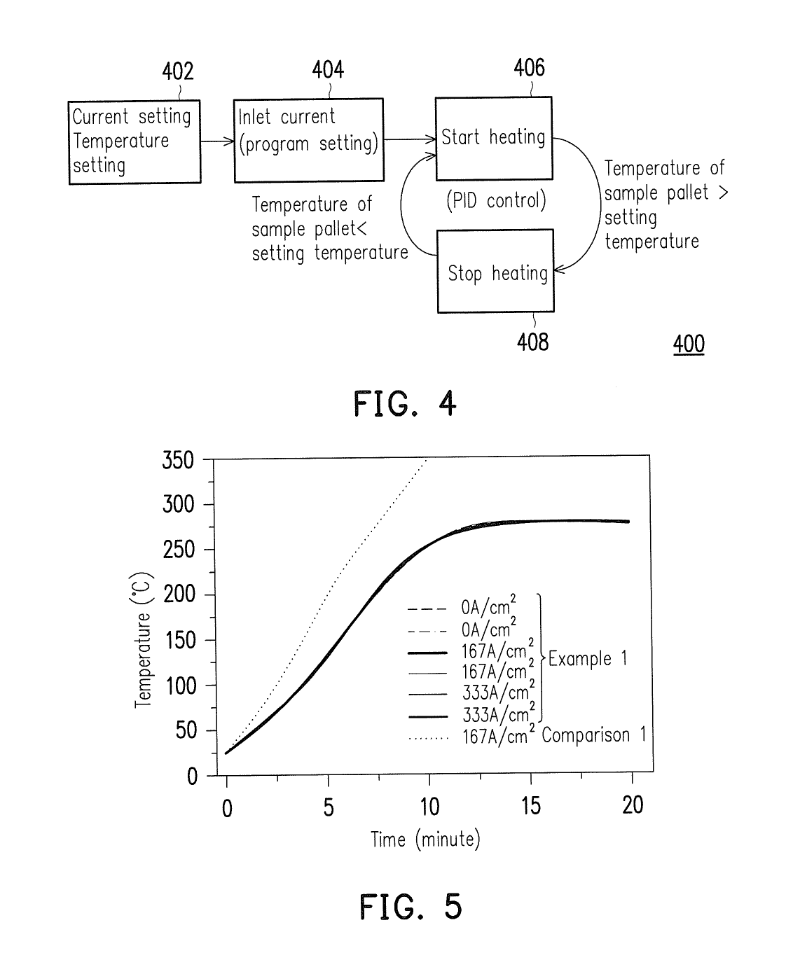

FIG. 4 is a control flowchart of the electrically assisted annealing apparatus of the disclosure.

Referring to FIG. 4, in step 402, a current magnitude and an annealing temperature of the electrically assisted annealing apparatus of the disclosure are simultaneously set. In step 404, a preset current is inlet to the sample pallet. In step 406, the sample pallet is heated to perform annealing treatment. When the annealing treatment is performed, different functional parts (for example, data extractors, a temperature controller, a mechanical pump, a power supplier, a gas flow meter and pressure gauge) are used to monitor a state in the electrically assisted annealing apparatus, and a PID controller is used to control a heating power of a heater. When the temperature of the sample pallet is higher than a setting temperature, a step 408 is executed to stop heating, and the sample pallet is cooled down through the high thermal conductive and electrical insulation blocks in the sample holder 310 (shown in FIG. 3B) of the disclosure. When the temperature of the sample pallet is lower than the setting temperature, a step 406 is executed again to start heating, and the heat provided by the heater is conducted to the sample pallet through the high thermal conductive and electrical insulation blocks to increase the temperature of the sample pallet. In this way, a good and stable annealing condition is maintained.

### Example 1

The sample holder having the BN high thermal conductive and electrical insulation blocks of the disclosure is used to test a temperature variation of a Bi—Sb—Te sample pallet under different current densities (0 A/cm², 167 A/cm², 333 A/cm²), and a result thereof is shown in FIG. 5.

Comparison 1

The sample holder without the BN high thermal conductive and electrical insulation blocks is used to test a temperature variation of a Bi—Sb—Te sample pallet under a current density of 167 A/cm², and a result thereof is shown in FIG. 5.

According to the result of FIG. 5, when the inlet current density of the sample pallet of the example 1 (sandwiched between the high thermal conductive and electrical insulation blocks) is 0 A/cm², 167 A/cm², 333 A/cm², a same temperature increasing curve is obtained, and the temperature control is good. When the inlet current density of the sample pallet of the comparison 1 (not sandwiched between the high thermal conductive and electrical insulation blocks) is 167 A/cm², the temperature is increased along a straight line without control, and a specific annealing temperature cannot be maintained. According to the above result, by using the BN high thermal conductive and electrical insulation blocks, the annealing temperature can be effectively controlled under high temperature.

### Example 2

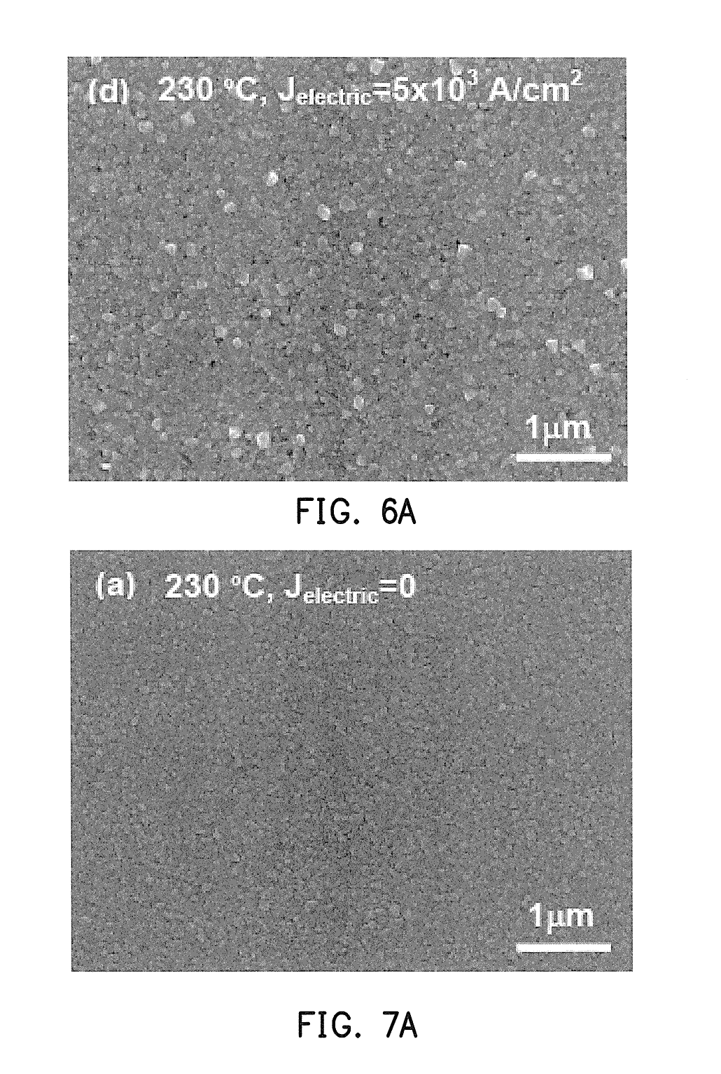

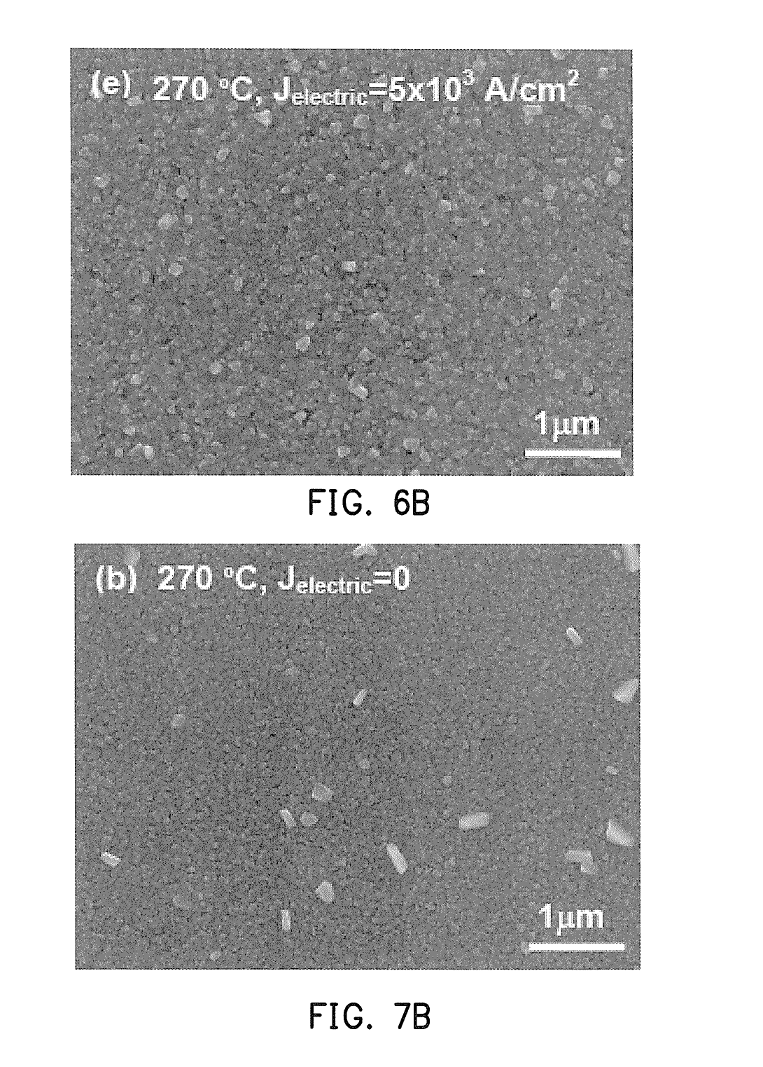

In case of electrically assisted annealing treatment of the Bi—Te—Se sample pallet under a current density of 4000 A/cm² and different temperatures (230° C., 270° C., 300° C.), the microstructures thereof are as shown in FIG. 6A, FIG. 6B and FIG. 6C.

Comparison 2

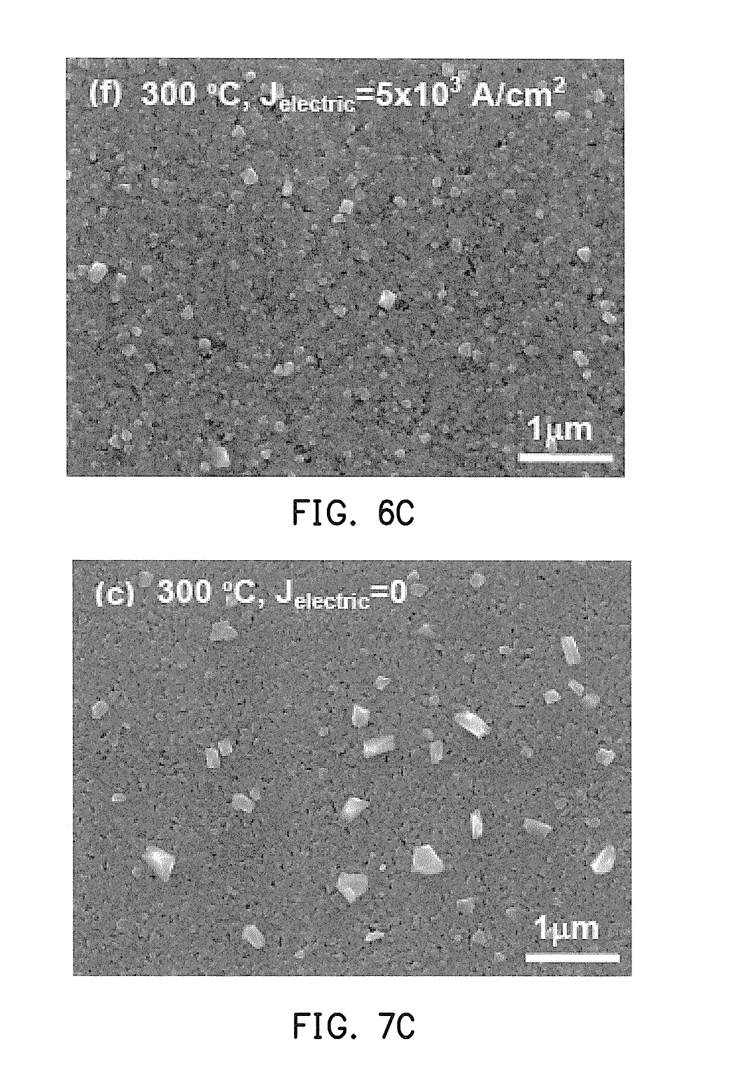

In case of simple thermal annealing treatment (without electrical assistance) of the Bi—Te—Se sample pallet under different temperatures (230° C., 270° C., 300° C.), the microstructures thereof are as shown in FIG. 7A, FIG. 7B and FIG. 7C.

According to FIG. 6A-FIG. 6C and FIG. 7A-FIG. 7C, it is known that regarding the annealing treatment under electrical assistance, a specific nanophase can be precipitated under a lower annealing temperature, and the precipitated phases are fine and even. Comparatively, regarding the simple thermal annealing treatment (without electrical assistance), the nanophase can be precipitated under a high annealing temperature, and the precipitated phases are irregular and rough. According to the above result, it is known that the electrically assisted annealing treatment has an effect that cannot be achieved by the simple thermal annealing treatment, by which the material is promoted to precipitate the specific nanophase under a lower annealing temperature, and the precipitated phases are fine and even.

### Example 3

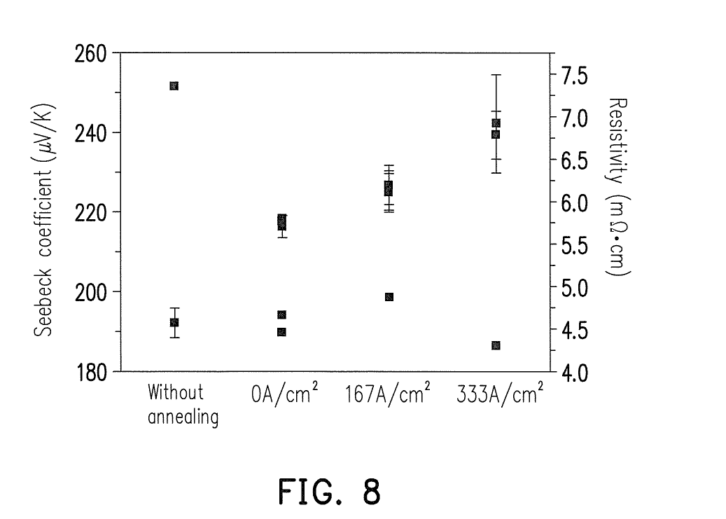

In case of electrically assisted annealing treatment of the Bi—Sb—Te sample pallet under a temperature of 275° C. and a current density of 167 A/cm², a relationship between a Seebeck coefficient α and a electrical resistivity ρ thereof is as shown in FIG. 8, and a thermoelectric characteristic (power factor P=α²/ρ) is as shown in a following table 1.

### Example 4

In case of electrically assisted annealing treatment of the Bi—Sb—Te sample pallet under a temperature of 275° C. and a current density of 333 A/cm², a relationship between the Seebeck coefficient α and the electrical resistivity ρ thereof is as shown in FIG. 8, and a thermoelectric characteristic is as shown in the following table 1.

Comparison 3

In case of a simple thermal annealing treatment of the Bi—Sb—Te sample pallet under a temperature of 275° C. (without electrical assistance, the electrical assistance is 0 A/cm²), a relationship between the Seebeck coefficient α and the electrical resistivity ρ thereof is as shown in FIG. 8, and a thermoelectric characteristic is as shown in a following table 1.

TABLE 1

| Annealing condition | Power factor(10⁻⁹W/K²cm) |
|---|---|
| Without annealing | 4981.5 |
| Comparison 3 | 10004.1 |
| Example 3 | 10442.2 |
| Example 4 | 13394.3 |

According to the table 1 and FIG. 8, the Seebeck coefficient α is increased along with increase of the annealing current density, and the electrical resistivity ρ is decreased along with increase of the annealing current density. According to the above result, by using the apparatus of the disclosure to perform the electrically assisted annealing treatment, an effect of improving the thermoelectric characteristic of the material is achieved.

In summary, the sample holder for annealing apparatus of the disclosure and the electrically assisted annealing apparatus using the same can control and stabilize a temperature and a current of the annealing treatment. The sample holder for annealing apparatus of the disclosure and the electrically assisted annealing apparatus using the same can promote the material to precipitate the specific nanophase under a lower annealing temperature, and the precipitated phases are fine and even. The sample holder for annealing apparatus of the disclosure and the electrically assisted annealing apparatus using the same can improve the thermoelectric characteristic of the material after the annealing treatment. The sample holder for annealing apparatus of the disclosure and the electrically assisted annealing apparatus using the same can satisfy requirements on consistency of annealing treatment parameters, reproductivity of material microstructures and characteristics, and optimal control of the material microstructures.

It will be apparent to those skilled in the art that various modifications and variations can be made to the structure of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A sample holder for annealing apparatus, comprising:
a heat conductive shell, comprising a base frame and a top cover;
a plurality of high thermal conductive and electrical insulation blocks, respectively disposed adjacent to the top of the base frame and the bottom of the top cover, wherein a sample pallet is sandwiched between the high thermal conductive and electrical insulation blocks; and
a first electrode and a second electrode, disposed opposite to each other between the high thermal conductive and electrical insulation blocks for contacting the sample pallet.

2. The sample holder for annealing apparatus as claimed in claim 1, wherein a material of the high thermal conductive and electrical insulation blocks comprises a ceramic material, metal with a surface treated with isolation treatment, alloy with a surface treated with isolation treatment or a combination thereof.

3. The sample holder for annealing apparatus as claimed in claim 2, wherein a material of the high thermal conductive and electrical insulation blocks comprises boron nitride (BN), aluminium nitride (AlN), beryllium oxide (BeO) or a combination thereof.

4. The sample holder for annealing apparatus as claimed in claim 1, wherein the heat conductive shell comprises metal or alloy.

5. The sample holder for annealing apparatus as claimed in claim 4, wherein a material of the heat conductive shell comprises copper, aluminium, alloy or metal-based composite materials that have a high thermal conductivity.

6. The sample holder for annealing apparatus as claimed in claim 1, wherein a material of the first electrode and the second electrode comprises metal or alloy.

7. The sample holder for annealing apparatus as claimed in claim 6, wherein a material of the first electrode and the second electrode comprises gold, silver, copper, nickel or an alloy thereof.

8. The sample holder for annealing apparatus as claimed in claim 1, further comprising a plurality of fixing sheets located at two sides of the sample pallet, wherein a material thereof comprises an insulation material.

9. The sample holder for annealing apparatus as claimed in claim 8, a material of the fixing sheets comprises a ceramic material, glass, aluminium oxide or a combination thereof.

10. The sample holder for annealing apparatus as claimed in claim 1, further comprising a thermocouple connected to the sample pallet.

11. The sample holder for annealing apparatus as claimed in claim 1, wherein components are fixed by using screws, springs or leaf springs.

12. The sample holder for annealing apparatus as claimed in claim 11, wherein components are fixed by using heat-resistant screws.

13. An electrically assisted annealing apparatus, comprising:
a sealed cavity;
a heater, disposed in the sealed cavity;
the sample holder for annealing apparatus as claimed in claim 1, disposed on the heater;
a first data extractor, disposed outside the sealed cavity, and configured to extract a temperature of the sample pallet;
a second data extractor, disposed outside the sealed cavity, and configured to extract a temperature of the heater;
a temperature controller, disposed outside the sealed cavity, and adjusting a power supplied to the heater according to the temperature of the sample pallet extracted by the first data extractor;
a mechanical pump, disposed outside the sealed cavity;
a power supplier, disposed outside the sealed cavity, and supplying a current to the sample pallet;
a gas flow meter and pressure gauge, disposed outside the sealed cavity, and controlling a gas inlet to the sealed cavity; and
a thermocouple external female connector, disposed outside the sealed cavity, and connected to the thermocouple of the sample holder and the first data extractor and the temperature controller.

14. The electrically assisted annealing apparatus as claimed in claim 13, further comprising a heater thermocouple configured to measure a temperature of the heater and connected to the second data extractor.

15. The electrically assisted annealing apparatus as claimed in claim 13, wherein the temperature controller is a proportional-integral-derivative controller.

16. The electrically assisted annealing apparatus as claimed in claim 13, wherein the gas inlet to the sealed cavity comprises nitrogen or inert gas.
